(19) United States
(12) Patent Application Publication
(10) Pub. No.: US 2019/0018893 A1
(43) Pub. Date: Jan. 17, 2019

(54) DETERMINING TONE DIFFERENTIAL OF A SEGMENT

(71) Applicant: Google Inc., Mountain View, CA (US)

(72) Inventors: Tania Bedrax Weiss, Sunnyvale, CA (US); Anna Patterson, Saratoga, CA (US); Charmaine Cynthia Rose D'Silva, Sunnyvale, CA (US); Advay Mengle, Sunnyvale, CA (US); Jindong Chen, Hillsborough, CA (US); Chih-Chun Chia, Mountain View, CA (US); Isaac Noble, Santa Cruz, CA (US); James Davidson, Oakland, CA (US)

(21) Appl. No.: 14/709,419

(22) Filed: May 11, 2015

Related U.S. Application Data
(60) Provisional application No. 61/992,120, filed on May 12, 2014.

(51) Int. Cl. G06F 17/30

(52) U.S. Cl. CPC G06F 17/30684; G06F 17/30864; G06F 17/30707; G06F 17/30011

(57) ABSTRACT

Methods and apparatus for determining a tone differential between a given segment of a document and a larger segment of the document. The tone differential may be based on comparison of a first tone associated with the given segment and a second tone associated with the larger segment. The tone differential is indicative of the variance between the tone of the given segment and the tone of the larger segment.

### BACKGROUND

Natural language processing techniques may be utilized to determine information about a document. For example, some natural language processing systems may enable determination of the overall sentiment expressed by a document.

### SUMMARY

This specification is directed generally to determining a tone differential of a segment, and, more particularly, to determining a tone differential of a given segment of a document based on comparison of a first tone associated with the given segment and a second tone associated with a larger segment of the document (e.g., the general tone of the entire document). Generally, the tone differential of the given segment is indicative of the variance between the tone of the given segment and the tone of the larger segment. For example, the tone of the given segment may be “informal”, the tone of the larger segment may be “formal”, and the tone differential may indicate the variance between the “informal” given segment and the “formal” larger segment. The tone differential may be associated with the given segment and optionally utilized to determine and/or provide additional information about the given segment and/or the document. For example, the tone differential may be utilized to provide an indication of the variance between the tone of the given segment and the tone of the larger segment of the document.

In some implementations a computer implemented method may be provided that includes the steps of: identifying a document; determining a first tone associated with a given segment of the document based at least in part on one or more segment terms of the given segment; determining a second tone associated with at least one or more additional segments of the document, wherein the at least one or more additional segments represent a larger portion of the document than the given segment; determining a tone differential between the given segment and the at least one or more additional segments based on comparison of the first tone and the second tone; and associating the tone differential with the given segment.

This method and other implementations of technology disclosed herein may each optionally include one or more of the following features.

In some implementations, the method may further include providing an indication related to the tone differential associated with the given segment. In some of those implementations, the providing the indication related to the tone differential associated with the given segment includes providing, to a client device, an indication of the given segment and of the tone differential.

In some implementations, the at least one or more additional segments comprise all segments of the document.

In some implementations, the method may further include identifying the given segment based on an association of the given segment with an entity; wherein associating the tone differential with the given segment comprises associating the tone differential with the entity. In some of those implementations, identifying the given segment based on association of the given segment with the entity includes: identifying a first text segment associated with the entity for inclusion in the given segment; and identifying a second text segment associated with the entity for inclusion in the given segment, the second text segment non-continuous with the first text segment. The first text segment may be in a first paragraph of the document and the second text segment may be in a second paragraph of the document.

In some implementations, determining the first tone associated with the given segment based at least in part on the one or more segment terms of the given segment includes providing the one or more segment terms to a tone classifier and receiving an indication of the first tone from the tone classifier.

In some implementations, the document is a message trail including one or more messages.

In some implementations, the determining the second tone associated with the at least one or more additional segments is based on one or more terms of the document. In some of those implementations, the determining the second tone associated with the at least one or more additional segments based at least in part on the one or more terms of the document includes providing the one or more terms to a tone classifier and receiving an indication of the second tone from the tone classifier.

In some implementations, the determining the second tone associated with the at least one or more additional segments is based on or more of a document identifier associated with the document and links associated with the document.

In some implementations, the at least one or more additional segments include the given segment.

Other implementations may include a non-transitory computer readable storage medium storing instructions executable by a processor to perform a method such as one or more of the methods described above. Yet another implementation may include a system including memory and one or more processors operable to execute instructions, stored in the memory, to perform a method such as one or more of the methods described above.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 illustrates an example environment in which a tone differential of a segment may be determined.

FIG. 2A illustrates a representation of a document, identified segments of the document, and additional document information associated with the document.

FIG. 2B illustrates a representation of the identified segments of the document of FIG. 2A and determined tones for the identified segments.

FIG. 3A illustrates a representation of another document, identified segments of the document, and additional document information associated with the document.

FIG. 3B illustrates a representation of the identified segments of the document of FIG. 3A and determined tones for the identified segments.

FIG. 4 is a flow chart illustrating an example method of determining a tone differential of a segment of a document.

FIG. 5 illustrates an example architecture of a computer system.

### DETAILED DESCRIPTION

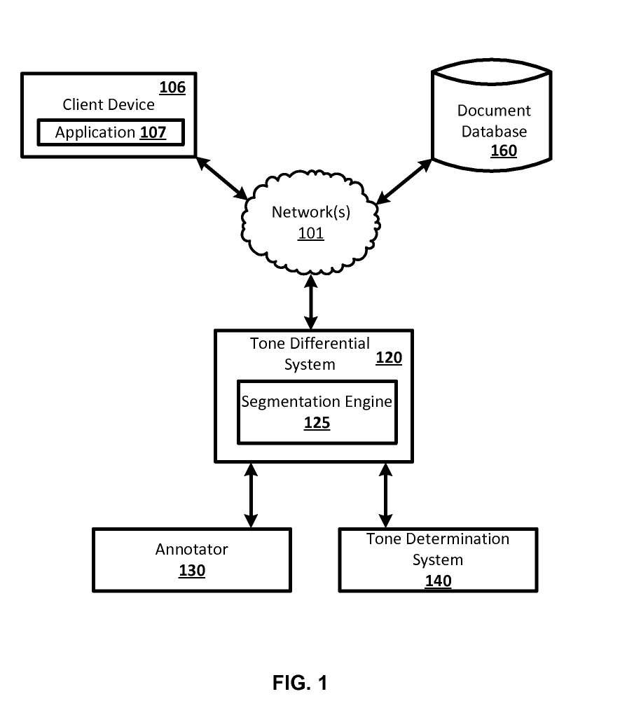

FIG. 1 illustrates an example environment in which a tone differential of a segment may be determined. The example environment includes a client device 106, a tone differential system 120, an annotator 130, a tone determination system 140, and a document database 160. The tone differential system 120 can be implemented in one or more computers that communicate, for example, through a network. The tone differential system 120 is an example of a system in which the systems, components, and techniques described herein may be implemented and/or with which systems, components, and techniques described herein may interface.

Generally, the tone differential system 120 determines a tone differential for each of one or more segments of a document, such as a document received from the client device 106 and/or document database 160. For example, the tone differential system 120 may determine the tone differential of a given segment of a document based on comparison of a first tone associated with the given segment and a second tone associated with a larger segment of the document. As used herein, a “tone” of one or more segments generally indicates one or more qualities of the one or more segments, as inferred by one or more systems based on content of the one or more segments and/or additional information associated with the one or more segments. A non-limiting list of examples of types of tone that may be determined includes: sarcastic/not sarcastic tones; formal/informal tones; positive/neutral/negative tones; critical/non-critical tones; demeaning/non-demeaning tones; and/or argumentative/non-argumentative tones. As described herein, determined tones and/or tone differentials may be represented as binary and/or non-binary measures.

As one example of determining tone differential, a document may be provided that is a message trail such as one or more emails, texts, and/or other messages exchanged between two or more parties. For example, the message trail may be provided to the tone differential system 120 by an application 107 executing on the client device 106, such as a text messaging application. A first tone may be determined for a given segment typed by a user in the message trail and a second tone may be determined for a larger segment of the message trail, such as the remainder of the message trail or the entirety of the message trail (including the given segment typed by the user). As described in more detail herein, in some implementations the tone determination system 140 may determine the first tone and/or the second tone based on one or more terms and/or features of the document. The tone differential system 120 may compare the first tone of the given segment to the second tone of the larger segment to determine a tone differential of the given segment. For example, the first tone may be “informal”, the second tone may be “formal”, and the tone differential system 120 may determine a tone differential that indicates the variance between the informal tone of the given segment and the formal tone of the larger segment. The tone differential system 120 may associate the tone differential with the given segment in memory and/or one or more databases. The tone differential may optionally be utilized for one or more purposes such as informing the user via client device 106 of the variance of the given segment from the remainder of the message trail.

As yet another example, a document may be a news article concerning a current event. For example, the document database 160 may include a collection of databases accessible via the Internet, such as a server of a news service that hosts documents, and the news article may be retrieved from the document database 160 by the tone differential system 120. A first tone may be determined for a paragraph of the document and a second tone also determined for the entirety of the document. The tone differential system 120 may determine a tone differential of the given segment based on comparison of the first tone and the second tone. For example, the first tone may be a “90% positive” tone about the current event, whereas the second tone may be a “60% positive” tone about the current event. The tone differential system 120 may determine a tone differential for the given segment that may indicate the variance between the tone of the given segment and the tone of the larger segment (e.g., 30% variance). The tone differential may be associated with the given segment and optionally utilized for one or more purposes. For example, the tone differential may be utilized to flag the given segment as being generally positive, but markedly less positive than the entirety of the document.

As yet another example of determining tone differential, a document may be provided that is a message trail of multiple messages exchanged between two or more parties. For example, the message trail may be provided to the tone differential system 120 by an application 107 executing on the client device 106, such as a text messaging application. A first tone may be determined for a first segment typed by a user in the message trail at a first time, a second tone may be determined for a second segment typed by the user in the message trail at a second time, a third tone may be determined for a third segment typed by the user in the message trail at a third time, etc. The tone differential system 120 may utilize metadata of the message trail to determine that the multiple segments were typed by the same user and/or to determine timestamps associated with each of the segments. As described in more detail herein, in some implementations the tone determination system 140 may determine the tones based on one or more terms and/or features of the document. The tone differential system 120 may compare the first tone, the second tone, and the third tone of the segments to determine a tone differential of the user over time. For example, the first tone may be “positive”, the second tone may be “neutral”, the third tone may be “negative” and the tone differential system 120 may determine a tone differential that indicates the tone of the user has progressed from positive to negative over time. The tone differential system 120 may associate the tone differential with an identifier of the user in memory and/or one or more databases. The tone differential may optionally be utilized for one or more purposes such as informing the user (via client device 106) and/or other parties of the message trail (via other client devices) of the progression of the user's tone from positive to negative over time.

In the example implementation of FIG. 1, the tone differential system 120 is in communication with the tone determination system 140. In some implementations, the tone determination system 140 and/or other engine may be incorporated with the tone differential system 120 to enable determination of the tone of one or more segments of a document by the tone differential system 120 directly. The tone determination system 140 may provide an indication of the tone for each of one or more segments of a document. For example, the tone determination system 140 may determine a tone of a given segment of the document such as one or more words, phrases, sentences, paragraphs, and/or sections of the document. As described herein, a segment of a document may be a continuous portion of a document such as a single paragraph or may include one or more non-continuous portions of a document such as all phrases and/or sentences that are associated with a particular entity. For example, five different sentences that mention an alias of entity X may be provided in five different paragraphs and the five sentences may collectively define a segment for which a tone is determined. Thus, in such an example, the tone of the segment may reflect tone associated with entity X in sentences provided across multiple paragraphs of the document. As another example, metadata and/or other data of a message trail may indicate all sentences that were typed or otherwise inputted by a particular user and those sentences may collectively define a segment for which a tone is determined.

In some implementations, the tone determination system 140 may receive as input one or more signals associated with one or more segments and provide as output an indication of the tone associated with the one or more segments. In some of those implementations, the tone determination system 140 may utilize classifier and/or rules based approaches to determine the tone based on the one or more signals. For example, the tone determination system 140 may be a tone detection classifier trained utilizing one or more supervised or semi-supervised training techniques.

The signals provided as input to the tone determination system 140 may include signals based on content of the document itself such as one or more terms of the document, parts of speech associated with one or more terms of the document, relationships between one or more terms of the document, and/or metadata of the document. For example, the signals utilized to determine the tone of a given segment may include signals based on content of segment itself such as one or more terms of the segment, parts of speech associated with one or more terms of the segment, relationships between one or more terms of the segment, and/or metadata associated with the segment. The signals may additionally or alternatively include signals based on neighboring and/or otherwise proximal segments. The signals utilized by the tone determination system 140 to determine tone may additionally or alternatively include signals based on additional information associated with the document such as, information related to a URL or other document identifier of the document (e.g., content of a URL containing “theonion.com” may be more likely to be sarcastic than content of a URL containing “nytimes.com”) and/or information related to links to and/or from the document (e.g., information based on descriptive text of the incoming links and/or information associated with the linking or linked documents). For example, the signals utilized to determine the tone of multiple segments of the document (e.g., of the entire document) may be based on additional information associated with the document.

In some implementations, the tone of a larger segment of the document that is determined and compared to the tone of a given segment of the document is a tone associated with the entirety of the document. For example, the tone determination system 140 may determine a tone based on content from the entirety of the document such as all identified “tone” terms and terms linked to the “tone” terms in the entirety of the document. As one example, the overall sentiment (e.g., positive, neutral, negative) associated with a textual consumer review may be determined via one or more natural language processing techniques applied to the text of the consumer review. In some implementations, the tone of the larger segment may be a tone associated with less than the entirety of the document. For example, the tone determination system 140 may determine a tone based on all identified “tone” terms in 75% of the document, all identified “tone” terms in one or more paragraphs of the document, or all identified “tone” terms in the non-boilerplate portions of the document. Additional and/or alternative techniques may be utilized to determine the larger segment for which tone will be determined for comparison to the tone of a given segment, such as techniques described in more detail herein. Moreover, as described herein, in some implementations multiple tone differentials may be determined for a given segment, based on comparison of the tone of the given segment to the tones of multiple larger segments. For example, a first tone differential of a sentence may be determined based on comparing the tone of the sentence to the tone associated with the entirety of the document and a second tone differential of the sentence may be determined based on comparing the tone of the sentence to the tone associated with a paragraph of which the sentence is a member.

In some implementations, a tone determined by the tone determination system 140 may be indicated as a binary measure (e.g., sarcastic or not sarcastic). In some implementations, a tone may be indicated as a non-binary measure that provides an indication of likelihood of the tone (e.g., 75% likely sarcastic, 60% likely non-sarcastic) and/or magnitude and/or polarity of the tone (e.g., very formal, somewhat formal, somewhat informal, very informal).

In some implementations, the tone determination system 140 may be configured to determine a specific type of tone. For example, the tone determination system 140 may be a classifier trained to determine presence of sarcasm and/or lack of sarcasm. In some implementations, the tone determination system 140 may be configured to determine multiple types of tone. For example, the tone determination system 140 may be a classifier trained to determine presence of sarcasm and/or lack of sarcasm and to also determine a degree of formalism. In some implementations, the tone determination system 140 may include multiple engines, each configured to determine one or more types of tone. For example, a first engine may employ rules and/or a classifier to determine a magnitude of positive or negative sentiment in one or more segments and a second engine may employ rules and/or a classifier to determine a magnitude of sarcasm in one or more segments.

In some implementations, terms and/or features associated with a given segment and/or a larger segment may be provided to the tone determination system 140 by the tone differential system 120. For example, as described in more detail below, in some implementations the segmentation engine 125 may identify segments of a given document and provide information related to one or more of the segments to the tone determination system 140. In some implementations, the tone determination system 140 may additionally and/or alternatively identify terms and/or features associated with one or more segments of a document directly from annotator 130 and/or directly from the document as received via the document database 160 and/or client device 106.

In some implementations, the terms and/or features provided to the tone determination system 140 may include annotations from the annotator 130. Such annotations may be provided to the tone determination system 140 as additional and/or alternative signals for utilization in determining tone. The annotator 130 may be configured to identify and annotate various types of grammatical information in one or more segments of a document. For example, the annotator 130 may include a part of speech tagger configured to annotate terms in one or more segments with their grammatical roles. For example, the part of speech tagger may tag each term with its part of speech such as “noun,” “verb,” “adjective,” “pronoun,” etc. Also, for example, in some implementations the annotator 130 may additionally and/or alternatively include a dependency parser configured to determine syntactic relationships between terms in one or more segments. For example, the dependency parser may determine which terms modify other terms, subjects and verbs of sentences, and so forth (e.g., a parse tree)—and may make annotations of such dependencies.

Also, for example, in some implementations the annotator 130 may additionally and/or alternatively include an entity tagger configured to annotate entity references in one or more segments such as references to people, organizations, locations, and so forth. For example, the entity tagger may annotate all references to a given person in one or more segments of a document. The entity tagger may annotate references to an entity at a high level of granularity (e.g., to enable identification of all references to an entity type such as people) and/or a lower level of granularity (e.g., to enable identification of all references to a particular entity such as a particular person). The entity tagger may rely on content of the document to resolve a particular entity and/or may optionally communicate with a knowledge graph or other entity database to resolve a particular entity. Also, for example, in some implementations the annotator 130 may additionally and/or alternatively include a coreference resolver configured to group, or “cluster,” references to the same entity based on one or more contextual cues. For example, “Daenerys Targaryen,” “Khaleesi,” and “she” in one or more segments may be grouped together based on referencing the same entity. In some implementations, the coreference resolver may use data outside of a textual segment (e.g., metadata or a knowledge graph) to cluster references. For instance, an email or other message may only contain a reference to “you” and the coreference resolver may resolve the reference to “you” to a person to which the message is addressed.

In some implementations, one or more components of the annotator 130 may rely on annotations from one or more other components of the annotator 130. For example, in some implementations the named entity tagger may rely on annotations from the coreference resolver and/or dependency parser in annotating all mentions to a particular entity. Also, for example, in some implementations the coreference resolver may rely on annotations from the dependency parser in clustering references to the same entity.

The tone differential system 120 includes a segmentation engine 125 that may segment a document into one or more segments for tone differential analysis. Segments may include, for example, one or more words, phrases, sentences, paragraphs, and/or sections of the document. For example, the segmentation engine 125 may segment the document by paragraphs and a tone may be determined for each of one or more of the paragraphs. A tone associated with a larger portion of the document, such as all paragraphs, may also be determined for comparison to the paragraph tones and determination of a tone differential of each of the paragraphs.

The segmentation engine 125 may employ one or more techniques to segment a document. For example, the segmentation engine 125 may segment textual portions of the document based on one or more characters in the textual portions such as periods, commas, semicolons, etc. For example, the document may be segmented into sentences based on periods in the document. Also, for example, the segmentation engine 125 may additionally and/or alternatively segment the document based on metadata of a document such as paragraph tags, section tags, author information associated with a segment, time stamps (e.g., when the document comprises multiple segments with different timestamps—such as a message trail), etc. For example, the segmentation engine 125 may segment the document into paragraphs based on paragraph tags in metadata of the document. Also, for example, the segmentation engine 125 may segment the document into time period segments based on timestamps in metadata of the document. For instance, a message trail may be segmented into multiple discrete messages that make up the message trail based on timestamps associated with the messages.

Also, for example, the segmentation engine 125 may additionally and/or alternatively segment the document based on annotations provided by annotator 130. For example, a dependency parser of the annotator 130 may provide annotations related to syntactic relationships between terms and the segmentation engine 125 may utilize such annotations to determine one or more phrases for inclusion in a segment of a document. As another example, an entity tagger of the annotator 130 may annotate all references to a given person in a document and the segmentation engine 125 may utilize such annotations to identify all phrases and/or sentences that reference the given person and include all such phrases and/or sentences in a given segment. For example, five different sentences scattered throughout the document may reference a given person and the segmentation engine 125 may determine a given segment of the document that includes those five different sentences.

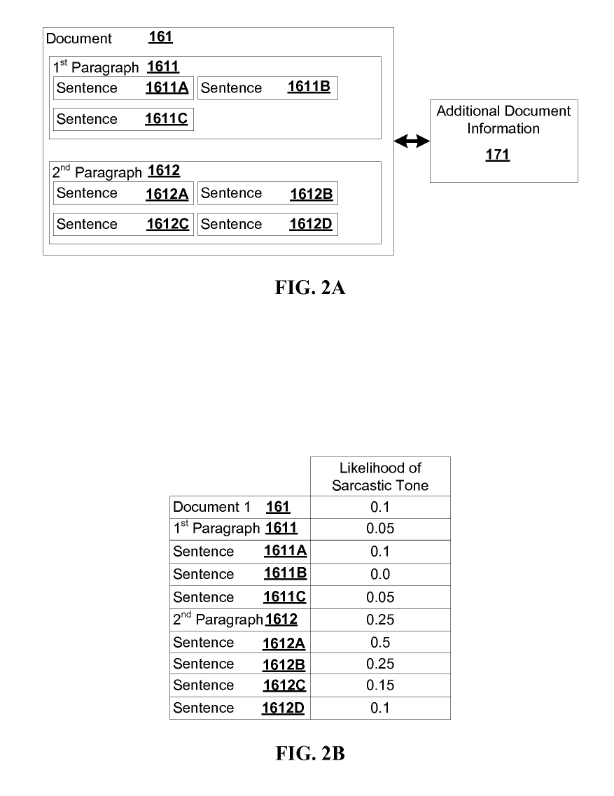

With reference to FIGS. 2A and 2B, an example of determining tone differential for one or more segments of a document is described. FIG. 2A illustrates a representation of a document 161 and segments that have been identified for the document. The document 161 may be, for example, a document identified via the document database 160 or a document identified via the client device 106. In the example, of FIG. 2A, the segments include 1^{st} paragraph 1611 and 2^{nd} paragraph 1612. The segments also include sentences 1611A-C, which are all members of the 1^{st} paragraph 1611. The segments also include sentences 1612A-D, which are all members of the 2^{nd} paragraph 1612.

In some implementations, the segmentation engine 125 may determine the segments based on one or more techniques such as those described herein. For example, the segmentation engine 125 may identify the paragraphs 1611 and 16112 based on paragraph breaks in metadata of the document. Also, for example, the segmentation engine 125 may identify the sentences 1611A-C and 1612A-D based on periods in the document. In some implementations, the segmentation engine 125 may utilize annotations of the document provided by the annotator 130 in determining the segments.

FIG. 2A also illustrates additional document information 171 that is associated with the document 161. The additional document information 171 may include, for example, information that is in addition to information determinable directly from the content of the document 161 itself, such as information related to a URL or other document identifier of the document and/or information related to links to or from the document. For example, additional document information related to a URL of the document may be indicative of general tone or other characteristics of other documents having the same domain, subdomain, and/or path of the URL. Also, for example, information related to links to or from the document may include information based on descriptive text of the incoming links and/or information associated with the linking or linked documents. For example, descriptive text of the incoming links may be indicative of a particular tone and/or the linking or linked documents may be indicative of a particular tone.

In some implementations, the tone determination system 140 may identify the additional document information 171 from one or more databases. For example, the document 161 may be associated with the additional document information 171 in an index that includes identifiers of documents and features associated with the documents, such as features that constitute additional information. In some implementations, the tone determination system 140 may determine the additional document information 171 directly. For example, the tone determination system 140 may determine tones associated with linking or linked documents and/or with other documents in the same domain of the document 161 and utilize one or more of the tones (or a summary measure thereof) as the additional information.

FIG. 2B illustrates a representation of identified segments of the document of FIG. 2A and determined tones for the segments. In the example of FIG. 2B, the determined tones indicate a likelihood of sarcastic tone on a scale from 0 to 1, with “1” indicating the greatest likelihood of a sarcastic tone and “0” indicating the least likelihood of a sarcastic tone.

In some implementations, the tone determination system 140 may determine the tone for each segment based on one or more signals associated with the segment. As described herein, the signals may include signals based on content of the segment itself, signals based on neighboring and/or otherwise proximal segments, and/or signals based on the additional document information 171. As also described, in some implementations the signals may include one or more signals based on annotations provided by annotator 130.

As one example, the tone determination system 140 may determine, for each of segments 1611, 1611A-C, 1612, and 1612A-D, the tone for the segment based on signals that are associated with the segment. For example, the tone determination system 140 may determine the tone for sentence 1611A based on one or more terms of the sentence, parts of speech associated with one or more terms of the sentence, and/or relationships between one or more terms of the sentence. Also, for example, the tone determination system 140 may determine the tone for the 1^{st} paragraph 1611 based on one or more terms of the paragraph, and/or parts of speech associated with the one or more terms of the paragraph.

The determined tones of FIG. 2B also include a tone associated with the document 161. The document 161 is associated with all of the segments of the document. In some implementations, the tone determination system 140 may determine the tone associated with the document 161 based on, for example, the additional document information 171, metadata of the document, one or more terms of the document, parts of speech associated with one or more terms of the document, and/or relationships between one or more terms of the document.

In some implementations, the tone determination system 140 may determine the tone for identified segments that encompass multiple other identified segments of the document based on determined tones for the encompassed multiple segments. For example, in some implementations the tone determination system 140 may determine the tone for the 1^{st} paragraph 1611 based at least in part on the individual tones determined for sentences 1611A-C. For example, the tone for the 1^{st} paragraph 1611 may be an average or other statistical measure of the individual tones determined for sentences 1611A-C. As another example, in some implementations the tone determination system 140 may determine the tone for the document 161 based at least in part on the individual tones determined for paragraphs 1611 and 1612 and/or the individual tones determined for sentences 1611A-C and sentences 1612A-D. For example, the tone for document 161 may be an average or other statistical measure of the individual tones determined for paragraphs 1611 and 16112. Other statistical measures may include, for example, an average with a standard deviation measure that indicates variation of the individual tones from the average.

The tone differential system 120 may determine a tone differential for one or more of the segments of FIGS. 2A and 2B. The tone differential of a given segment of a document is based on comparison of a tone associated with the given segment and a tone associated with a larger portion of the document. For example, the tone differential system 120 may determine a tone differential of sentence 1612A based on comparison of the tone of “0.5” for sentence 1612A to a tone associated with a larger portion of the document, such as the tone of “0.1” associated with the document 161. Also, for example, the tone differential system 120 may additionally and/or alternatively determine a tone differential for sentence 1612A based on comparison of the tone of “0.5” for sentence 1612A to the tone of “0.25” associated with the second paragraph 1612.

In some implementations, a tone differential of a given segment may indicate a magnitude of variance (if any) between the given segment and a larger segment. For example, the tone differential may be based on determining the difference between the tone of the given segment and the tone of the larger segment. For example, the tone differential between sentence 1612A and the document 161 may be “0.4” (0.5−0.1). As another example, the tone of the larger segment may be represented as an average with a standard deviation measure. The tone differential may be based on determining the difference between the tone of the segment and one standard deviation from the average tone of the larger segment. Additional and/or alternative techniques may be utilized to determine a tone differential of a given segment that indicates a magnitude of variance between the given segment and a larger segment.

In some implementations, the tone differential may indicate whether sufficient variance between a given segment and a larger segment exists, without indicating the magnitude of the variance. For example, the tones of the given segment and larger segment may be binary measures (e.g., formal/informal) and the tone differential may indicate whether the tones of the given segment and the larger segment are different. Also, for example, a different between non-binary tones may be determined, compared to a threshold, and if the threshold is satisfied the tone differential may indicate sufficient variance. For example, if the tones are provided on a scale from 0 to 1, a tone differential that is greater than “0.25” may indicate sufficient variance. As another example, the tone of the larger segment may be represented as an average with a standard deviation measure. The tone differential may indicate sufficient variance if the tone of the given segment is beyond one standard deviation from the average. Additional and/or alternative techniques may be utilized to determine a tone differential of a given segment that indicates whether sufficient variance between the given segment and a larger segment exists, without indicating the magnitude of the variance.

The determined tone differential may be associated with the given segment in memory and/or one or more databases. For example, in some implementations the association between the tone differential and the given segment may be included in an index entry for the document 161.

In some implementations, the tone differential of a given segment may optionally be utilized by the tone differential system 120 and/or other components to match the given segment and/or the document to a search query; and/or to determine and/or provide additional information about the given segment and/or the document. For example, a search system or other information retrieval system may utilize the association between the tone differential and the given segment in identifying the document and/or segment as responsive to a particular search query and/or in ranking the document and/or segment for the search query. Also, for example, the tone differential system 120 may utilize the determined tone differential to provide an indication of the variance of the tone of the given segment from the tone of the larger segment of the document. For example, the given segment may be flagged as being “more sarcastic” than the remainder of the document. Flagging of the segment may include, for example, highlighting the segment, underlining of the segment, a popup window from the segment or that otherwise identifies the segment, etc. The tone differential system 120 may flag the segment via modification of the document and/or via output provided to one or more applications providing the document to a user, such as application 107. For example, output may be provided to a browser application of the computing device that is rendering the document that causes the rendering of the document to be modified (e.g., the segment to be highlighted).

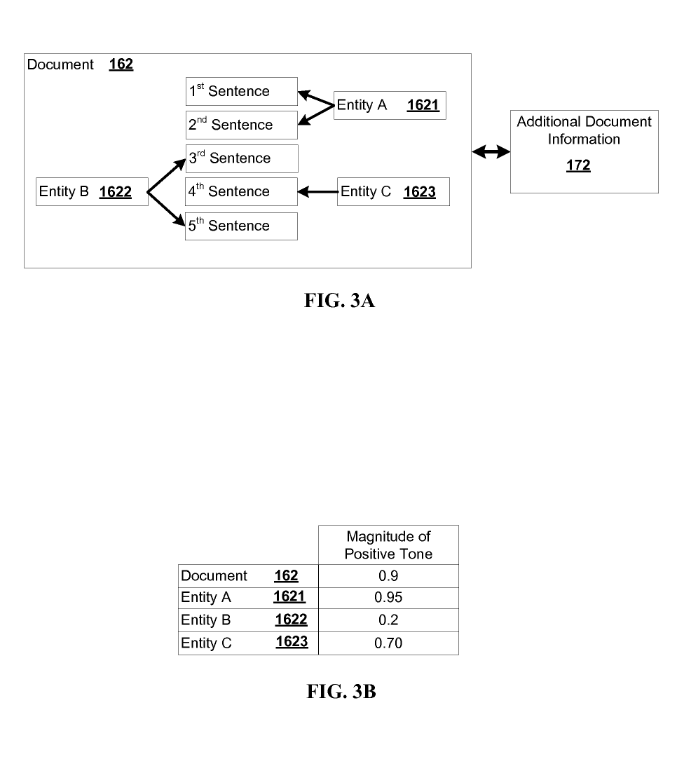

With reference to FIG. 3A and FIG. 3B, another example of determining tone differential of one or more segments of a document is described. FIG. 3A illustrates a representation of a document 162 and segments that have been identified for the document 162. The document 162 may be, for example, a document identified via document database 160 or a document identified via client device 106. In the example of FIG. 3A, the segments include: Entity A segment 1621 that includes the 1^{st} and 2^{nd} sentence; Entity B segment 1622 that includes the 3^{rd} sentence and the 5^{th} sentence; and Entity C segment 1623 that includes the 4^{th} sentence.

In some implementations, the segmentation engine 125 may determine the segments based on one or more techniques such as those described herein. For example, an entity tagger of the annotator 130 may annotate all references to entities in a document. The segmentation engine 125 may utilize such annotations to identify, for each entity, a segment that includes all sentences that reference the entity. For example, the segmentation engine 125 may identify the 3^{rd} and 5^{th} sentences reference the same entity based on annotations of annotator 130, and include the 3^{rd} and 5^{th} sentences in Entity B segment 1622.

FIG. 3A also illustrates additional document information 172 that is associated with the document 162. The additional document information 172 may include, for example, information that is in addition to information determinable directly from the content of the document 162 itself, such as information described above with respect to FIGS. 2A and 2B.

FIG. 3B illustrates a representation of identified segments of the document of FIG. 3A and determined tones for the segments. In the example of FIG. 3B, the determined tones indicate a magnitude of the positive tone on a scale from 0 to 1, with “1” indicating the most positive tone and “0” indicating the least positive tone. In some implementations, the tone determination system 140 may determine the tone for each segment based on one or more signals associated with the segment. As described herein, the signals may include signals based on content of the segment itself, signals based on neighboring and/or otherwise proximal segments, and/or signals based on the additional document information. As also described, in some implementations the signals may include one or more signals based on annotations provided by annotator 130.

As one example, the tone determination system 140 may determine, for each of segments 1621, 1622, and 1623, the tone for the segment based on signals that are associated with the segment. For example, the tone determination system 140 may determine the tone for Entity B segment 1622 based on one or more terms of the 3^{rd} and 5^{th} sentences, parts of speech associated with one or more terms of those sentences, and/or relationships between one or more terms of those sentences. The determined tones of FIG. 3B also include a tone associated with the document 162. The document 162 is associated with all of the segments of the document. In some implementations, the tone determination system 140 may determine the tone for document 162 based on, for example, the additional document information 172, based on metadata of the document, based on one or more terms of the document, parts of speech associated with one or more terms of the document, and/or relationships between one or more terms of the document. As described with respect to FIGS. 2A and 2B, in some implementations the tone determination system 140 may optionally determine the tone for segments that encompass multiple segments of the document based on determined tones for the encompassed multiple segments.

The tone differential system 120 may determine a tone differential for one or more of the segments of FIGS. 3A and 3B. For example, the tone differential system 120 may determine a tone differential of the Entity B segment 1622 based on comparison of the tone of “0.2” for the Entity B segment 1622 to a tone associated with a larger segment of the document, such as the tone of “0.9” associated with the document 162. As described with respect to FIGS. 2A and 2B, in some implementations, the tone differential may indicate a magnitude of variance (if any) between a given segment and a larger segment. In some implementations, the tone differential may indicate whether sufficient variance between a given segment and a larger segment exists, without indicating the magnitude of the variance.

The determined tone differential may be associated with the given segment in memory and/or one or more databases. In some implementations, associating the tone differential with the given segment may include associating the tone differential with the entity of the given segment. For example, the tone differential for the Entity B segment 1622 may be associated with Entity B. Determined tone differentials may optionally be utilized by the tone differential system 120 and/or other components to provide additional information about the entity, the given segment, and/or the document. For example, the tone differential system 120 may utilize the determined tone differential of the Entity B segment 1622 relative to the document 162 to provide an indication that the tone associated with Entity B is markedly less positive than the tone associated with the document 162. Where the identified entities are individuals or characters, this may enable determination of those individuals or characters that have a markedly different tone. Where the identified entities are objects or features, this may enable determination of those objects or features that are associated with a markedly different tone than other objects or features.

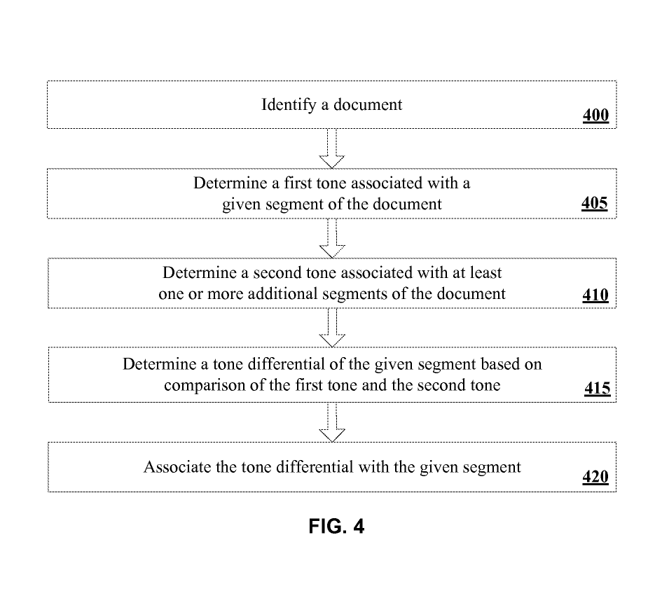

With reference to FIG. 4, a flow chart is provided that illustrates an example method of determining a tone differential of a segment of a document. Other implementations may perform the steps in a different order, omit certain steps, and/or perform different and/or additional steps than those illustrated in FIG. 4. For convenience, aspects of FIG. 4 will be described with reference to a system of one or more computers that perform the process. The system may include, for example, the tone differential system 120 and/or the tone determination system 140 of FIG. 1.

At step 400, a document is identified. In some implementations, the tone differential system 120 may identify the document via the client device 106 or via the document database 160.

At step 405, a first tone associated with a given segment of the document is determined. For example, the tone differential system 120 may provide an indication of the given segment to the tone determination system 140 and the tone determination system 140 may determine a tone of the given segment based on one or more signals associated with the given segment. As described herein, the signals may include, for example, one or more terms associated with the segment, parts of speech of the terms, metadata associated with the segment, signals based on proximal segments, and/or additional data associated with the document. In some implementations, one or more of the signals may include annotations provided by annotator 130. The tone determination system 140 may provide an indication of the determined tone to the tone differential system 120.

The given segment of the document may be, for example, one or more words, phrases, sentences, paragraphs, and/or sections of the document. As described herein, in some implementations the segmentation engine 125 may determine the given segment based on content of the document and/or annotations provided by annotator 130. As also described herein, in some implementations the segmentation engine 125 may determine the given segment based on the components of the given segment all referencing a given entity or all being created by a given user.

At step 410, a second tone associated with at least one or more additional segments of the document is determined. For example, the tone differential system 120 may provide an indication of the at least one or more additional segments to the tone determination system 140 and the tone determination system 140 may determine a tone of at least one or more additional segments based on one or more signals associated therewith.

In some implementations, the at least one or more additional segments of the document represent a larger portion of the document than the given segment of step 405. For example, in some implementations the at least one or more additional segments may include the given segment and one or more additional segments. For instance, the given segment may be a sentence in a paragraph and the at least one or more additional segments may include the sentence and additional sentences of the paragraph. Also, for example, in some implementations the at least one or more additional segments may include all segments of the document. For instance, a tone that is associated with all segments of the document may be determined based on “tone” terms throughout the document and/or additional information associated with the document. Also, for example, in some implementations the at least one or more additional segments may be less than the entirety of the document. For example, the tone determination system 140 may determine a tone based on all identified “tone” terms in 75% of the document (optionally including the given segment), all identified “tone” terms in one or more paragraphs of the document (optionally including the given segment), or all identified “tone” terms in the non-boilerplate portions of the document (optionally including the given segment).

At step 415, a tone differential of the given segment is determined based on comparison of the first tone and the second tone. For example, the tone differential system 120 may determine a tone differential of a given segment based on comparison of the tone associated with the given segment and the tone associated with the one or more additional segments. In some implementations, a tone differential of a given segment may indicate a magnitude of variance (if any) between the given segment and a larger segment. For example, the tone differential may be based on determining the difference between the first tone associated the given segment and the second tone associated with the one or more additional segments (e.g., tone differential=second tone−first tone). In some implementations, the tone differential may indicate whether sufficient variance between the first tone associated with the given segment and the second tone associated with the one or more additional segments exists, without indicating the magnitude of the variance. For example, the first tone and the second tone may be binary measures (e.g., formal/informal) and the tone differential may indicate whether the first tone and the second tone are different.

At step 420, the tone differential is associated with the given segment. For example, the tone differential system 120 may associate the determined tone differential with the given segment in memory and/or one or more databases. For example, in some implementations the association between the tone differential and the given segment may be included in an index entry for the document. In some implementations, the tone differential of a given segment may optionally be utilized by the tone differential system 120 and/or other components to match the given segment and/or the document to a search query; and/or to determine and/or provide additional information about the given segment and/or the document.

As described in various examples, a user may interact with the tone differential system 120 via the client device 106. In some implementations, one or more applications executing on the client device 106, such as application 107, may provide all or portions of a document to the tone differential system 120 for determining of tone differential of one or more segments of the document. For example, the application 107 may be a messaging application and content of past messages in a message trail and a current message being prepared for the message trail may be provided to the tone differential system 120. An indication of a determined tone differential may be provided by the tone differential system 120 to the application 107. In some implementations, a user may have control over whether content and/or which content may be provided to the tone differential system 120 by one or more applications of the client device 106.

In some implementations, a user may indirectly interact with the tone differential system 120 via the client device 106. For example, as described herein, the tone differential system 120 may determine a tone differential for a segment of a document and store an indication of the tone differential in one or more databases, such as an in an index entry for the document. In some implementations, a search system or other information retrieval system may utilize the association between the tone differential and the given segment in identifying the document is responsive to a search query issued from the client device 106 and/or in identifying the segment is responsive to the search query. Also, in some implementations an application 107 may utilize the association between the tone differential and the given segment in presenting the document to the user (e.g., by flagging the segment) and/or in presenting a summary of information about the document to the user. Other computer devices may interact with the tone differential system 120 such as additional client devices and/or one or more servers. For brevity, however, certain examples are described in the context of the client device 106.

The client device 106 may be a computer coupled to the tone differential system 120 through one or more networks 101 such as a local area network (LAN) or wide area network (WAN) (e.g., the Internet). The client device 106 may be, for example, a desktop computing device, a laptop computing device, a tablet computing device, a mobile phone computing device, a computing device of a vehicle of the user (e.g., an in-vehicle communications system, an in-vehicle entertainment system, an in-vehicle navigation system), or a wearable apparatus of the user that includes a computing device (e.g., a watch of the user having a computing device, glasses of the user having a computing device). Additional and/or alternative client devices may be provided.

As used herein, a document is any data that is associated with a document identifier such as, but not limited to, a uniform resource locator (“URL”). Documents include web pages, word processing documents, portable document format (“PDF”) documents, images, videos, emails, SMS/text messages, feed sources, calendar entries, task entries, to name just a few. Each document may include content such as, for example: text, images, videos, sounds, embedded information (e.g., meta information and/or hyperlinks); and/or embedded instructions (e.g., ECMAScript implementations such as JavaScript).

In this specification, the term “database” and “index” will be used broadly to refer to any collection of data. The data of the database and/or the index does not need to be structured in any particular way and it can be stored on storage devices in one or more geographic locations. Thus, for example, the document database 160 may include multiple collections of data, each of which may be organized and accessed differently. Also, for example, all or portions of the document database 160 may contain pointers and/or other links between entries in the database(s).

In situations in which the systems described herein collect personal information about users, or may make use of personal information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

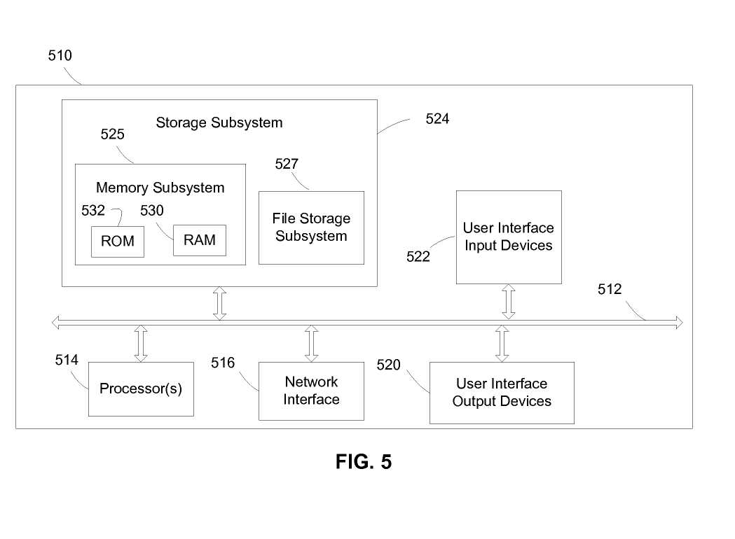

The tone differential system 120, the annotator 130, the tone determination system 140, and/or one or more additional components of the example environment of FIG. 1 may each include memory for storage of data and software applications, a processor for accessing data and executing applications, and components that facilitate communication over a network. In some implementations, such components may include hardware that shares one or more characteristics with the example computer system that is illustrated in FIG. 5. The operations performed by one or more components of the example environment may optionally be distributed across multiple computer systems. For example, the steps performed by the tone differential system 120 may be performed via one or more computer programs running on one or more servers in one or more locations that are coupled to each other through a network.

Many other configurations are possible having more or fewer components than the environment shown in FIG. 1. For example, in some environments the segmentation engine 125 may not be a separate module of the tone differential system 120. Also, for example, in some implementations one or both of the annotator 130 and the tone determination system 140 may be incorporated in the tone differential system 120.

FIG. 5 is a block diagram of an example computer system 510. Computer system 510 typically includes at least one processor 514 which communicates with a number of peripheral devices via bus subsystem 512. These peripheral devices may include a storage subsystem 524, including, for example, a memory subsystem 525 and a file storage subsystem 527, user interface input devices 522, user interface output devices 520, and a network interface subsystem 516. The input and output devices allow user interaction with computer system 510. Network interface subsystem 516 provides an interface to outside networks and is coupled to corresponding interface devices in other computer systems.

User interface input devices 522 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 510 or onto a communication network.

User interface output devices 520 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 510 to the user or to another machine or computer system.

Storage subsystem 524 stores programming and data constructs that provide the functionality of some or all of the modules described herein. For example, the storage subsystem 524 may include the logic to perform one or more of the methods described herein such as, for example, the method of FIG. 4.

These software modules are generally executed by processor 514 alone or in combination with other processors. Memory 525 used in the storage subsystem can include a number of memories including a main random access memory (RAM) 530 for storage of instructions and data during program execution and a read only memory (ROM) 532 in which fixed instructions are stored. A file storage subsystem 527 can provide persistent storage for program and data files, and may include a hard disk drive, a floppy disk drive along with associated removable media, a CD-ROM drive, an optical drive, or removable media cartridges. The modules implementing the functionality of certain implementations may be stored by storage subsystem 524 in the file storage subsystem 527, or in other machines accessible by the processor(s) 514.

Bus subsystem 512 provides a mechanism for letting the various components and subsystems of computer system 510 communicate with each other as intended. Although bus subsystem 512 is shown schematically as a single bus, alternative implementations of the bus subsystem may use multiple busses.

Computer system 510 can be of varying types including a workstation, server, computing cluster, blade server, server farm, or any other data processing system or computing device. Due to the ever-changing nature of computers and networks, the description of computer system 510 depicted in FIG. 5 is intended only as a specific example for purposes of illustrating some implementations. Many other configurations of computer system 510 are possible having more or fewer components than the computer system depicted in FIG. 5.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A computer-implemented method, comprising:
identifying a message trail utilizing one or more processors;
determining, utilizing one or more of the processors, a first tone associated with a given segment of the message trail based at least in part on one or more segment terms of the given segment, wherein the given segment is typed by a user via an application executing on a client device of the user;
determining, utilizing one or more of the processors, a second tone associated with at least one or more additional segments of the message trail, wherein the at least one or more additional segments represent a larger portion of the message trail than the given segment, and wherein the one or more additional segments include at least one additional segment, from the message trail, that is from an additional user, that is directed to at least the user, and that precedes, in time, the given segment typed by the user;
determining, utilizing one or more of the processors, a tone differential between the given segment and the at least one or more additional segments based on comparison of:
the first tone associated with the given segment, and
the second tone associated with the one or more additional segments; and
providing, for presentation by the client device via the application via which the user typed the given segment, output that is based on the determined tone differential and that indicates variance of the given segment of the message trail from the one or more additional segments of the message trail.

2. (canceled)

3. (canceled)

4. The computer-implemented method of claim 1, wherein the at least one or more additional segments comprise all segments of the message trail.

5. (canceled)

6. (canceled)

7. (canceled)

8. The computer-implemented method of claim 1, wherein the determining the first tone associated with the given segment based at least in part on the one or more segment terms of the given segment includes providing the one or more segment terms to a tone classifier and receiving an indication of the first tone from the tone classifier.

9. (canceled)

10. The computer-implemented method of claim 1, wherein the determining the second tone associated with the at least one or more additional segments is based on one or more terms of the message trail.

11. The computer-implemented method of claim 10, wherein the determining the second tone associated with the at least one or more additional segments based at least in part on the one or more terms of the message trail includes providing the one or more terms to a tone classifier and receiving an indication of the second tone from the tone classifier.

12. (canceled)

13. The computer-implemented method of claim 1, wherein the at least one or more additional segments include the given segment.

14. A computer system, comprising:
a memory including stored instructions, the instructions including instructions to:
identify a document rendered by an application,
identify a given segment of the document based on association of the given segment with an entity, wherein the given segment includes a first text segment associated with the entity, and a second text segment associated with the entity, wherein the first text segment is included in the document, the second text segment is included in the document, and the second text segment is non-continuous with the first text segment;
determine a first tone associated with the given segment of the document based at least in part on one or more segment terms of the given segment,
determine a second tone associated with at least one or more additional segments of the document, wherein the at least one or more additional segments represent a larger portion of the document than the given segment,
determine a tone differential between the given segment of the document and the at least one or more additional segments of the document based on comparison of the first tone and the second tone, and
modify rendering of the document by the application based on the tone differential, wherein the instructions to modify the rendering of the document include instructions to visually flag the given segment as differing in tone from the at least one or more additional segments; and
one or more processors operable to execute the instructions stored in the memory.

15. (canceled)

16. (canceled)

17. The system of claim 14, wherein the at least one or more additional segments comprise all segments of the document.

18. (canceled)

19. (canceled)

20. The system of claim 14, wherein the instructions to determine the first tone associated with the given segment based at least in part on the one or more segment terms of the given segment includes instructions to provide the one or more segment terms to a tone determination system and receive an indication of the first tone from the tone determination system.

21. The system of claim 14, wherein the instructions to determine the second tone associated with the at least one or more additional segments include instructions to determine the second tone based on one or more terms of the document.

22. The system of claim 14, wherein the instructions to determine the second tone associated with the at least one or more additional segments include instructions to determine the second tone based on one or more of a document identifier associated with the document and links associated with the document.

23. The system of claim 14, wherein the at least one, or more additional segments include the given segment.

24. A non-transitory computer readable storage medium storing computer instructions executable by a processor to perform a method comprising:
identifying a message trail;
determining a first tone associated with a given segment of the message trail based at least in part on one or more segment terms of the given segment, wherein the given segment is typed by a user via an application executing on a client device of the user;
determining a second tone associated with at least one or more additional segments of the message trail, wherein the at least one or more additional segments represent a larger portion of the message trail than the given segment, and wherein the one or more additional segments include at least one additional segment, from the message trail, that is from an additional user, that is directed to at least the user, and that precedes, in time, the given segment typed by the user;
determining a tone differential between the given segment and the at least one or more additional segments based on comparison of:
the first tone associated with the given segment, and
the second tone associated with the one or more additional segments; and
providing, for presentation by the client device via the application via which the user typed the given segment, output that is based on the determined tone differential and that indicates variance of the given segment of the message trail from the one or more additional segments of the message trail.
